(19) United States
(12) Patent Application Publication
(10) Pub. No.: US 2013/0101636 A1
(43) Pub. Date: Apr. 25, 2013

(54) DIETARY SUPPLEMENTS WITH RAPID BUCCAL DISSOLUTION

(71) Applicant: Kevin W. Lang, Lloyd Neck, NY (US)

(72) Inventor: Kevin W. Lang, Lloyd Neck, NY (US)

(21) Appl. No.: 13/650,887

(22) Filed: Oct. 12, 2012

Related U.S. Application Data
(60) Provisional application No. 61/546,519, filed on Oct. 12, 2011.

(51) Int. Cl. A23L 1/29; B65D 85/00

(52) U.S. Cl. CPC A23L 1/293; B65D 85/00
USPC 424/400; 514/52; 514/345; 514/167; 514/474; 426/73; 426/648; 206/530

(57) ABSTRACT

There is provided a dietary supplement product comprising a sealed package containing a single dose of a dietary supplement, the dietary supplement including one or more active agents such as vitamins and mineral dispersed with a carrier so that it is in the form of a free-flowing, dry particulate which pours readily and dissolves rapidly on the tongue.

This application claims priority under 35 U.S.C. §119(e) to U.S. Provisional Patent Application Ser. No. 61/546,519, filed Oct. 12, 2011, the entire contents of which are hereby incorporated by reference herein.

### FIELD OF INVENTION

The present invention relates to dietary supplements for oral delivery in particulate form. The particulates contain one or more active agents and dissolve rapidly in the mouth with a pleasant texture and taste.

### BACKGROUND

Dietary supplements are an important adjunct to a healthy diet. Generally, dietary supplements are oral compositions having a nutritive benefit or otherwise intended to supplement the diet. Numerous supplements are available including mineral supplements like magnesium, iron, and calcium tablets, so called “letter vitamins” such as Vitamin A, Vitamins B₁ (Thiamin), B₂ (Riboflavin), B₃ (Niacin), B₅ (Pantothenic Acid), B₆ (Pyridoxine), B₇ (Biotin), B₉ (Folic Acid), and B₁₂ (Cyanocobalamin), Vitamin C, Vitamins D₂ and D₃, Vitamin E, and Vitamin K, vitamin-like substances such as Coenzyme-Q₁₀, multivitamins and multiminerals, glucosamine and chondroitin, probiotics, and a range of herbal supplements, to name just a few. They typically take the form of solid or liquid dosage forms.

Many of these supplements are available only in large tablets or capsules that may be difficult for some to comfortably swallow. Moreover, the process of tableting may restrict the use or levels of certain desirable ingredients. There is therefore a continuing need in the art for improved delivery of dietary supplements.

### SUMMARY OF INVENTION

In accordance with the foregoing objectives and others, there is provided a dietary supplement product comprising a sealed package containing a single dose of a dietary supplement, the dietary supplement including one or more active agents dispersed with a carriers (typically a dextrose carrier having a coarse particle size profile characterized by a percent retention on a 16 US mesh screen of less than 1% by weight, a percent retention on a 30 US mesh screen of less than 10% by weight, and less than 20% by weight passing through a 100 US mesh screen), wherein the dietary supplement is in the form of a free-flowing, dry particulate which dissolves rapidly on the tongue. The dietary supplement product may include printed instructions on the packaging or associated instructions indicating that the composition should be poured directly into the oral cavity without first mixing with water or other diluent.

The active agent may be any dietary adjuvant, such as vitamins, minerals, herbal supplements, and the like. In a preferred aspect, the active ingredient may comprise a calcium carbonate granulation, and optionally vitamin D, alone or in combination with a carbohydrate carrier such as dextrose. The composition may contain a disintegrant such as povidone/crospovidone or Sodium Starch Glycolate.

These and other aspects of the invention will be better understood by a reading of the following detailed description and appended claims.

### DESCRIPTION

Dietary supplement products are provided comprising a sealed package containing a single dose of a dietary supplement. The sealed package is typically a flexible material such as paper, plastic, or laminated materials folded into tubes having the ends sealed, by heat treatment or the like. The package is typically designed to be opened by the user by tearing or cutting, for example along a scored line, perforation, or the like.

The dietary supplement is in particulate form, by which is meant that it is powdered or granular. What is important is that the material is free-flowing so that it may be poured from the torn packaging directly onto the tongue or otherwise into the mouth of a user. The dietary supplements are dry, by which is meant that they contain no more water than typically associated with the individual components and, in any event, an amount of hydration sufficiently low so that the product flows freely and tends not to clump when the package is squeezed. The dietary supplement dissolves rapidly on the tongue. For example, a single dose of the product may dissolve completely on the tongue within 30 seconds, more typically 20 seconds, preferably within 10 seconds, and more preferred still within 5 seconds. Of course, there may be variance from individual to individual and the foregoing represent averages based on panel testing or the like.

What is unique about the inventive dietary supplements is that they are orally consumed directly in particulate form and preferably not first mixed or dissolved with a diluent such as water. In that regard, the packaging may include instructions for using the product including instructions on tearing open the package, pouring the contents directly into the mouth, and preferably the instructions will indicate that the product is to be consumed without first mixing with a diluent.

The packages are preferably charged with a single dose of dietary supplement, by which is meant an amount to be consumed as a single bolus. This amount is preferably an amount sufficient to provide at least a referenced daily intake of a particular vitamin, mineral, or other dietary supplement, or may provide a fraction of such referenced dietary intake such that a dosing regiment comprising administering two or more packages a day is sufficient to achieve the referenced dietary intake.

The dietary supplements include one or more active agents. The active agents may be vitamins, minerals, herbs, botanicals, amino acids, or other dietary supplements. For example, suitable active agents include: alpha lipoic acid, antioxidants, Vitamin A, Vitamins B₁ (Thiamin), B₂ (Riboflavin), B₃ (Niacin), B₅ (Pantothenic Acid), B₆ (Pyridoxine), B₇ (Biotin), B₉ (Folic Acid), and B₁₂ (Cyanocobalamin or Methylcobalamin), B-Complex, Vitamin C, Vitamins D₂ and D₃, Vitamin E, and Vitamin K (e.g., Menaquinone-7), vitamin-like substances such as Coenzyme-Q₁₀, ascorbic acid, sodium ascorbate, niacinamide ascorbate, folic acid, iron, iodine, Magnesium (Oxide, Aspartate, Gluconate, or Citrate), zinc (Zinc Gluconate, Oxide, Aspartate, etc.), selenium, copper, manganese, chromium (Picolinate), boron, potassium (citrate), molybdenum, vanadyl sulfate, strontium (citrate), inorganic calcium (e.g., calcium carbonate, calcium oxide, etc.), calcium hydroxyapatite, organic calcium salts (e.g., calcium aspartate, calcium citrate, calcium malate, calcium citrate malate, etc.), glucosamine sulfate, glucosamine hydrochloride, and N-acetylglucosamine, chondroitin sulfate, msm, green tea, kava kava, saw palmetto, St. Johns' wort, tribulus, verba mate, horny goat weed, acai, milk thistle, CoQ-10, hyaluronic acid, amino acids (e.g., L-Arginine, L-Gultamine, L-Lysine, L-Ornithine, L-Theanine, L-Tryptophan, L-Tryrosine), L-Carnitine, Acetyl-L-Carnitine, L-Carnosine, carotenoids (e.g., lutein), melatonin, bioflavonoids, 7-Keto DHEA (3-Acetyl-7-Oxo-Dehydroepiandrosterone), procyanids, bromelain, quercetin, resveratrol, lecithin, Black cohosh, Beta Sitosterol, alone or in combination.

In one embodiment, the active agents are dispersed with a carrier, preferably a saccharide, such as dextrose, and more preferred still a monohydrate dextrose carrier. In a preferred embodiment, the monohydrate dextrose carrier will have a coarse particle size profile, ideally characterized by a percent retention on a 16 US mesh screen of less than 1% by weight, a percent retention on a 30 US mesh screen of less than 10% by weight, and less than 20% by weight passing through a 100 US mesh screen. Typically, only a trace amount of material will be retained on a 16 US mesh screen. The preferred monohydrate dextrose will have moisture content between about 8 and about 9% by weight, typically about 8.5% by weight. Ideally, the saccharide carrier, such as the monohydrate dextrose, will have a generally rounded particle shape and will be highly porous. A dextrose carrier characterized by the preferred particle size parameters is believed to have an unexpectedly superior rate of dissolution and superior mouthfeel as compared to other carbohydrate carriers.

The dextrose will typically comprise from about 5% to about 99% of the composition, more typically from about 10% to about 95%, and preferably from about 25% to about 90% of the composition. In one embodiment, dextrose comprises the majority of the weight of the composition, including embodiments of about 50-60%, about 60-70%, about 70-80%, about 80-90%, and about 90-95% by weight.

The term “particulate” refers to a solid, preferably a solid at room temperature (21 C), which exists in powdered form, granular form, or both. By powder is generally meant particles having an average diameter less than 1000 microns. By granular is generally meant particles having an average diameter equal to or greater than 1000 microns. In some, but not all embodiments, it may be preferred not to use particles having an average diameter greater than about 1000 microns depending on the solubility of the particle in the mouth. In one embodiment, the median particle size of some or all of the particulate components of the composition is less than 3 millimeters, alternatively less than 2 millimeters, alternatively less than 1 millimeter. In one embodiment, the median particle size of some or all of the particulate ingredients will be less than 500 microns or less than about 350 microns. Moreover, in other embodiments, at least 50%, 60%, 70%, 80%, 90%, 95%, or 99% of the composition passes through a mesh of U.S. Sieve Size 5, 6, 7, 8, 10, 12, 14, 16, 18, 20, 25, 30, 35, 40, 45, 50, or 60, each being considered to be a separate embodiment of the invention. For example, in one embodiment, at least 90%, 95%, or at least 99% of the composition passes through U.S. Sieve Size 20.

In another embodiment, the compositions may be in the form of a granulated mineral, such as a calcium carbonate granulation. In this embodiment, the composition does not necessarily include a carrier such as a saccharide but improvements in mouth feel, dissolution, and overall acceptability are expected to be obtained when a carbohydrate (e.g., dextrose) carrier is employed, including the preferred monohydrate dextrose described herein.

The calcium carbonate granulations include without limitation those described in U.S. Pat. No. 7,198,653, the disclosure of which is hereby incorporated by reference in its entirety. These granulations typically are prepared from calcium carbonate powders having a median particle size between about 0.1 and about 25 microns, including specific embodiments with particle sizes of about 4 μm, about 6 μm, 10 μm, about 12 μm, about 15 μm and about 20 μm. The granulations are prepared according to a wet granulation technique wherein the calcium carbonate powder is mixed under high-shear, for example in a high-shear mixer, with a carbohydrate binder such as starch or maltodextrin, in the presence of about 5% to about 20% by weight water (preferably in the form of steam). The granulations may also include excipients such as mineral or vegetable oil, and lubricants such as magnesium stearate to name a few. The granulations are typically dried to a water content of less than about 1% by weight using a drying technique that fluidizes the material, for example with a flow of air and/or a vibrating bed. One example of such a technique is a fluidized bed oven, preferably a horizontal fluidized bed oven. The calcium carbonate granulations will typically comprise between about 80% to about 98% by weight calcium carbonate powder, more typically from about 85 to about 95% by weight calcium carbonate powder; from about 1% to about 10% by weight, more typically from about 2% to about 6% by weight, and preferably about 4.5% to about 5.5% of the carbohydrate binder (e.g., maltodextrin); and 0.1 to about 2% by weight of the oil, with any remainder optionally comprising additional excipients or active agents (e.g., vitamin D). A preferred maltodextrin will have a dextrose equivalent (DE) of about 100 to about 180 (preferably about 100). The granulations will typically have a tap density greater than or equal to about 0.9 g/cm³, preferably greater than about 1.0 g/cm³, up to about 2.0 g/cm³, and will pass through an 18×18 US mesh screen. The calcium carbonate is preferably a USP grade, ideally one having acid insoluble removed to a level of less than 2.5%, preferably less than 1%, or even better less than 0.5% by weight. The calcium carbonate granulations are typically free flowing particulates. In one embodiment, the granulated calcium carbonate will pass through an 18×18 US mesh sieve.

The calcium carbonate granulation compositions may further contain one or more vitamins or other minerals. For example, they may contain vitamin D (in the form of either ergocalciferol or cholecalciferol) in an amount from about 100 IU up to about 5,000 IU, typically from about 400 IU to about 2,000 IU.

In one embodiment, an individual package contains an amount of composition sufficient to provide 500 mg to 2g of elemental calcium in a single dose, preferably 600 mg to 1,300 mg of elemental calcium in a single dose. The packages are torn at one end by the user and the contents are poured directly into the mouth. The composition will have a smooth mouthfeel and will dissolve rapidly.

The compositions of the invention may include other excipients, such as preservatives, flavorants, sweeteners, fragrances, lubricants, desiccants, and colorants (pigments, lakes, dyes, etc.). All components should be suitable for human consumption. Notable excients include magnesium stearate, maltodextrin, silica, talc, water-soluble polymers (hydroxypropyl methyl cellulose, hydroxypropylcellulose, and other cellulosics, PVP, crospovisone, etc.), adipic acid, lecithin, Carbowax (polyethylene glycols), to name a few. Preferred excipients are disintegrants and so-called “superdisintegrants” such as Polyplasdone (PVP/Crospovidone) and/or Sodium Starch Glycolate.

The composition preferably has a moisture content of less than about 12% by weight and more typically less than about 10% by weight, and a water activity of less than 0.91, more typically less than 0.87, preferably less than 0.80, more preferably less than 0.75, and more preferred still less than 0.70.

The packaging is typically in the form of a sealed package made of paper, cardboard or plastic. The package may be, for example, tubular or flat and will typically be made from folded paper that is sealed (optionally with an adhesive) at the edged. The package may contain a perforation or demarcation at one end designating a location at which the package can be torn to be opened and through which the content may be poured, preferably directly into the mouth of a human. In a preferred embodiment, the package is in the form of a stick pack which is generally an elongated, tube shaped paper packet sealed across and at both ends. Such packages include those available from Stick Pack USA, Inc. The packaging is typically between about 1-8 inches in length, more typically between 1.5-7 inches, more typically between about 2-6 inches, and preferably between about 2.5-5 inches in length. The package will typically be between ⅛ inch and one (1) inch in width, more typically between ¼ and ¾ inches in width, including embodiments of about ¼ to about ½ inches in width.

The package will be charged with the compositions of the invention, which are in particulate or other solid form, such that they do not significantly absorb into or through the packaging but are readily pourable from the package and easily dissolved in the oral cavity. The package may bear printed instructions indicating that the contents are to be poured directly into the mouth, preferably without first mixing with water or a water-containing beverage.

The packages with contain anywhere from about 10 mg to about 15 g of composition, typically from 50 mg to about 10 g, more typically from about 100 mg to about 5 g. In certain embodiments, the packages will contain from about 100-500 mg, about 500-1,000 mg, about 1-2 g, about 2-5 g, or about 5-10 grams of the compositions of the invention.

Exemplary compositions according to the invention are provided in Tables 1 through 5, below.

TABLE 1
Rapid Melt B-12/1000 MCG and Vitamin D/10000 IU

| RAW MATERIAL | MG/TAB |
|---|---|
| VIT B12 1.0% SD/CYANOCOBALAMIN | 120.00 |
| DRY VIT D3 100-SD/S-CHOLECAL | 14.00 |
| LECITHIN/EPIKURON 100P1 | 14.00 |
| VIT B6/PYRIDOXINE HCL 82.27% PYR | 0.28 |
| 23201 FLV STR N&A FONA 915.772 | 7.4 |
| SIPERNAT 50S/SIL DIOXIDE 43.0% SI | 1.20 |
| CER 2037/DEXTROSE | 267.00 |
| MALTRIN M510/MALTODEXTRIN | 47.00 |
| EXPLOTAB/SOD STARCH GLYC | 9.00 |
| POLYPLASDONE XL/CROSPOVIDONE | 9.00 |
| CARBOWAX 8000 PDR/POLY GLYC | 10.40 |
| MAGNESIUM STEARATE | 0.72 |
| Total | 500.00 mg |

TABLE 2
Rapid Melt Calcium 600 MG W/VIT D3 800 IU Lemon

| RAW MATERIAL | MG/TAB |
|---|---|
| GRAN CAL GARB OC USP/NF AA-API | 1789.80 |
| DRY VIT D3 100-SD/S-CHOLECAL | 12 |
| DEXTROSE 2037 | 1601.50 |
| 4013 FLV FIR 502.142 LEMON | 20.60 |
| FD&C YELL#5 Al LAKE 15-17% | 2.40 |
| ADIPIC ACID NF | 40.00 |
| TALC USP | 60.20 |
| MAGNESIUM STEARATE | 3.50 |
| Total | 3530.00 mg |

TABLE 3
Rapid Melt Vitamin D/1000 IU Cherry

| RAW MATERIAL | MG/TAB |
|---|---|
| DRY VIT D3 100-SD/S-CHOLECAL | 15 |
| CER 2037/DEXTROSE | 1283.0 |
| CHERRY FLAVOR ART SD (VD #405) | 20 |
| CREAM FLAVOR SD NAT (18312) | 5 |
| FD&C RED 40 ALUMINUM LAKE 36-42% | 3.5 |
| ADIPIC ACID NF | 35 |
| MAGNESIUM STEARATE | 15.5 |
| TALC USP BC | 63 |
| Total | 1440 |

TABLE 4
Rapid Melt Calcium Carbonate 500 MG Orange

| RAW MATERIAL | MG/TAB |
|---|---|
| GRAN CAL GARB OC USP/NF AA-API | 596.6 |
| CER 2037/DEXTROSE | 515.00 |
| ORANGE FLAVOR NA SD (VD #583) | 8 |
| FD&C YEL #6 AL LAKE 15-18% | 1.6 |
| ADIPIC ACID NF | 14 |
| CARBOWAX 8000 PWDR/POLY GLYCOL | 38.4 |
| TALC USP BC | 26.4 |
| Total | 1200.00 |

TABLE 5
Rapid Melt Vitamin C 500 MG Orange

| RAW MATERIAL | MG/TAB |
|---|---|
| ASCORBIC ACID 97DC | 219 |
| SODIUM ASCORBATE 89% VIT C | 354 |
| CERELOSE 2037/DEXTROSE | 886 |
| SUCRALOSE PDR | 1 |
| NAT ORANGE DURAROME 860483 TD0590 | 20 |
| NAT ORANGE JUICE SD POWDER | 3 |
| FD&C YELLOW #6 AL LAKE 17-19% | 5 |
| MAGNESIUM STEARATE | 12 |
| Total | 1500.00 |

The foregoing compositions are packaged in individual stick packs

The invention having been described by the foregoing description of the preferred embodiments, it will be understood that the skilled artisan may make modifications and variations of these embodiments without departing from the spirit or scope of the invention as set forth in the following claims.

We claim:

1. A dietary supplement product comprising a sealed package containing a single dose of a dietary supplement, the dietary supplement including one or more active agents dispersed with a monohydrate dextrose carrier having a coarse particle size profile characterized by a percent retention on a 16 US mesh screen of less than 1% by weight, a percent retention on a 30 US mesh screen of less than 10% by weight, and less than 20% by weight passing through a 100 US mesh screen, wherein said dietary supplement is in the form of a free-flowing, dry particulate which dissolves rapidly on the tongue.

2. A dietary supplement product according to claim 1, wherein said one or more active agents is selected from the group consisting of vitamin D2, vitamin D3, vitamin B6, vitamin B12, ascorbic acid, sodium ascorbate, niacinamide ascorbate, thiamin, riboflavin, niacin, folic acid, biotin, pantothenic acid, iron, iodine, magnesium, zinc, selenium, copper, manganese, chromium, molybdenum, vitamin K, and combinations thereof.

3. A dietary supplement product according to claim 2, wherein said dietary supplement comprises from about 50% to about 99% by weight monohydrate dextrose and an amount of a flavorant sufficient to mask the taste of said one or more vitamins.

4. A dietary supplement product according to claim 3, wherein said dietary supplement comprises at least 6 micrograms of vitamin B12 (as cyanocobalamin).

5. A dietary supplement product according to claim 3, wherein said dietary supplement comprises at least 2 mg of vitamin B6 (as pyridoxine hydrochloride).

6. A dietary supplement product according to claim 3, wherein said dietary supplement comprises at least 1,000 IU of vitamin D3 (as cholecalciferol).

7. A dietary supplement product according to claim 3, wherein said monohydrate dextrose comprises from about 85% to about 95% by weight of said dietary supplement.

8. A dietary supplement product according to claim 1, wherein said one or more active agents have been blended with said monohydrate dextrose in a V-blender.

9. A dietary supplement product according to claim 1, wherein said sealed package comprises a flexible tube having sealed ends configured to be torn or cut to provide an opening for dispensing the dietary supplement.

10. A dietary supplement product according to claim 9, wherein said sealed package includes printed instructions to pour said dietary supplement directly into the mouth.

11. A dietary supplement product according to claim 10, wherein said sealed package further includes printed instructions to pour said dietary supplement directly into the mouth without first dissolving the dietary supplement in a diluent.

12. A dietary supplement product comprising a sealed package containing a single dose of a dietary calcium supplement, the dietary calcium supplement including a calcium carbonate granulation prepared from calcium carbonate powder having a median particle size between about 0.1 and about 25 μm and a carbohydrate binder, the dietary calcium supplement further including a flavorant and, optionally, vitamin D3, wherein said dietary supplement is in the form of a free-flowing, dry particulate which dissolves rapidly on the tongue.

13. A dietary supplement product according to claim 12, wherein said calcium carbonate granulation is prepared by mixing said calcium carbonate powder and said carbohydrate binder in the presence of about 5% to about 15% by weight water in a high-shear mixer.

14. A dietary supplement product according to claim 13, wherein said calcium carbonate granulation is dried in a fluidized bed oven.

15. A dietary supplement product according to claim 14, wherein the fluidized bed oven is a horizontal fluidized bed oven.

16. A dietary supplement product according to claim 12, wherein said dietary calcium supplement further includes a monohydrate dextrose having a coarse particle size profile characterized by a percent retention on a 16 US mesh screen of less than 1% by weight, a percent retention on a 30 US mesh screen of less than 10% by weight, and less than 20% by weight passing through a 100 US mesh screen.

17. A dietary supplement product according to claim 16, wherein said monohydrate dextrose is included in said calcium carbonate granulation.

18. A dietary supplement product according to claim 16, wherein said monohydrate dextrose is blended with said calcium carbonate granulation.

20. A dietary supplement product according to claim 19, wherein said calcium carbonate powder has a median particle size between about 9 to about 16 μm.

21. A dietary supplement product according to claim 12, wherein said granulated calcium carbonate comprises from about 80% to about 98% by weight calcium carbonate.

22. A dietary supplement product according to claim 12, wherein said granulated calcium carbonate comprises from about 40% to about 75% by weight of said dietary supplement.

23. A dietary supplement product according to claim 22, wherein said granulated calcium carbonate comprises from about 45% to about 55% by weight of said dietary supplement.

24. A dietary supplement product according to claim 18, wherein said monohydrate dextrose comprises from about 35% to about 55% by weight of said dietary supplement.

25. A dietary supplement product according to claim 12, wherein said dietary supplement comprises at least about 800 IU of vitamin D3.

26. A dietary supplement product according to claim 12, wherein said single dose comprises an amount of calcium carbonate sufficient to provide at least 600 mg of element calcium.

27. A dietary supplement product according to claim 1, wherein said dietary supplement is essentially free of ascorbic acid, niacinamide ascorbate, and sodium ascorbate.

28. A dietary supplement product according to claim 12, wherein said dietary supplement is essentially free of ascorbic acid, niacinamide ascorbate, and sodium ascorbate.
